(19) United States
(12) Patent Application Publication
(10) Pub. No.: US 2026/0260311 A1
(43) Pub. Date: Sep. 3, 2026

(54) CODING VIDEO DATA ON A GPU

(71) Applicant: V-NOVA INTERNATIONAL LIMITED, London (GB)

(72) Inventor: Charvi MEHTA, London (GB)

(21) Appl. No.: 19/151,097

(22) PCT Filed: Jan. 26, 2024
(86) PCT No.: PCT/GB2024/050209

§ 371 Date: Jul. 25, 2025

(30) Foreign Application Priority Data
Jan. 27, 2023 (GB) 2301217.2

(51) Int. Cl. G06T 1/20; G06F 9/30

(52) U.S. Cl. CPC G06T 1/20; G06F 9/30036

(57) ABSTRACT

There is provided a method a method of processing image data on a GPU. The method comprising: receiving image data to be processed; identifying a kernel to be used to process the image data according to a convolutional filter operation; and signalling to the GPU to use one or more tensor operations as necessary to perform at least some of the convolutional filter operation on the image data to produce output data.

### TECHNICAL FIELD

The disclosure relates to the processing of image data by a GPU. Particularly, but not exclusively, the disclosure relates to the coding of video data using GPU cores.

### BACKGROUND

When coding video data on a GPU, there are often other applications requesting and using resources simultaneously. When the coding requires minimum latency overhead, this can often be a problem as the coding processes are queued until the necessary resources become free. An aim of the invention is to allow video coding on a GPU to proceed with reduced latency and increased throughput in these circumstances.

### SUMMARY

According to a first aspect of the invention, there is provided a method of processing image data on a GPU. The method comprising: receiving image data to be processed; identifying a kernel to be used to process the image data according to a convolutional filter operation; and signalling to the GPU to use one or more tensor operations as necessary to perform at least some of the convolutional filter operation on the image data to produce output data.

In this way, the video coding process can make use of multiple resources in the GPU simultaneously, thus avoiding resource contention. For example, CUDA cores may be used to perform the convolutional filter operation until CUDA core resources are in high demand, when at that time tensor cores are used to perform the tensor operations. Alternatively, tensor cores may be used when high data throughput is needed.

Preferably, the identifying comprises creating a kernel matrix from the kernel so that the convolutional filter operation can be performed by matrix multiplication using tensor operations on the GPU. Preferably, when the kernel is a 2D kernel it is transposed into a 1D kernel prior to creating the kernel matrix and the image data is adapted accordingly to populate an input matrix. Preferably, the image data is reordered to populate an or the input matrix so that when multiplied by the kernel matrix the output data obtained is equivalent to the convolutional filter operation. Preferably, the kernel matrix is or contains a transposed circulant matrix derived from the kernel. The kernel matrix may be diagonally constant or contain diagonally constant elements. Preferably, the method further comprises populating any columns of the kernel matrix that cannot accommodate the kernel according to the transposed circulant matrix with zero values once the transposing of the kernel is done and arranging the image data into successive input matrices accordingly to obtain the desired output data to recreate the output data that would have been produced by the convolutional filter operation.

Preferably, the image data is organised into one or more input matrices according to the matrix size requirements of the tensor operations. Preferably, the input matrix width dimension and the kernel height dimension are chosen to match each other and so that the kernel matrix can accommodate the kernel. Preferably, the input matrix width dimension and the kernel height dimension are chosen so that the kernel matrix has a relatively lower or lowest available sparsity (i.e., having a large number of zero or near-zero values among the entries of the kernel) for the given kernel. Preferably, operative matrices are used (M, N, K), wherein M is the height of the input matrix, N is the width of the kernel matrix and K is the width of the input matrix and the height of the kernel matrix. Typically, one of the following matrix sizes for operative matrices are used (M, N, K): 16, 16, 16; 16, 8, 16; 16, 8, 8; 16, 16, 32; 16, 8, 32; and 8, 8, 32 depending on the image data and the kernel.

Preferably, the method comprises reordering the output data as needed to recreate the output data that would have been produced by the convolutional filter operation.

Preferably, the convolutional filter operation is one of the following: downsampling; upsampling; or another filtering operation or combination of downsampling or upsampling and another filtering operation.

Preferably, the method of processing image data is part of a coding process involving independently encodable and decodable parts. Preferably, the independently encodable and decodable parts are one or more of: encode or decode a base layer; encode or decode an enhancement layer; encode or decode part of an enhancement layer while in parallel simultaneously decoding another part of the same enhancement layer; upsampling a base layer while decoding an enhancement layer, or part thereof.

Preferably, wherein the signalling to the GPU comprises signalling using a cooperative matrix extension. Preferably, wherein the signalling to the GPU involves specifying the instruction in a particular way different to a normal instruction. Preferably, wherein the signalling comprises using metadata.

Preferably, the method comprises initialising a shared kernel buffer and temporary buffer memories.

According to a second aspect of the invention, there is provided a method of coding image data on a GPU. The method comprising: arranging image data to be processed into parallel tasks within respective compute units on the GPU; identifying one of the parallel tasks as being a suitable task for processing using tensor operations; and signalling to the GPU that tensor operations are suitable for that task.

In this way, the video coding process can make use of multiple resources in the GPU simultaneously, reducing latency and increasing throughput.

Preferably, the suitable task is one of the following: downsampling; upsampling; or filtering.

Preferably, the method of coding image data involves independently encodable and decodable parts. Preferably, the independently encodable and decodable parts are one or more of: encode or decode a base layer; encode or decode an enhancement layer; encode or decode part of an enhancement layer while in parallel simultaneously decoding another part of the same enhancement layer; upsampling a base layer while decoding an enhancement layer, or part thereof.

Preferably, wherein the signalling to the GPU comprises signalling using a cooperative matrix extension. Preferably, wherein the signalling to the GPU involves specifying the instruction in a particular way different to a normal instruction (i.e., without using Cooperative Matrix Multiplication extension and the commands (in the shader) that come with it). Preferably, wherein the signalling comprises using metadata.

Embodiments are particularly useful in video coding because known (e.g. video) coding methods do not utilise tensor operations. An example of suitable hardware configured to perform a tensor operation is a ‘tensor core’, which is a processing core created by Nvidia®. An Intelligence Processing Unit (created by Graphcore®) may also be considered as a suitable hardware configured to perform a tensor operation. A tensor operation may thus describe a module of a processor (in particular a GPU) that has one or more of the following properties: it can perform multiple operations per clock cycle; can be configured to perform matrix multiplication; can enable mixed-precision computing to dynamically adapt calculations; can operate with single instruction multiple data. A tensor core may enable mixed-precision computing where the inputs are at lower precision but the final output is at higher precision. A tensor core may be configured to perform GEMM (GEneral Matrix Multiply) tensor operations, typically work at lower-precision inputs to gain higher throughput.

Instead, known coding methods use: specific hardware modules designed to code (i.e. encode and/or decode) in accordance with a specific coding scheme; general purpose cores of a GPU (e.g. a CUDA core); a CPU. However, tensor cores were designed for the purpose of machine learning (e.g. processing neural networks), therefore embodiments utilise that the tensor core will be unused during coding. Therefore, embodiments that utilise a tensor core during coding data (e.g. video data, image data, point cloud, mesh data) may yield surprisingly improved results in terms of throughput and reduced latency.

Moreover, the inventors determined that utilising a tensor core when coding is even more advantageous when the coding scheme is one or more of: a hierarchical coding scheme; and a coding scheme where frames can be independently encoded/decoded of other frames (where a sequence of multiple frames is being coded); a coding scheme where coding units within a frame can be independently encoded/decoded from other coding units (e.g. other coding units within the same frame).

The inventors have determined that, in relation to hierarchical coding schemes, a first layer of the hierarchical coding scheme may be coded with a ‘traditional’ coding resource (e.g. hardware block such as a hardware encoder for a specific coding scheme and/or a hardware decoder for a specific coding scheme, software encoder using libraries provided by them on CPU. etc), and another layer hierarchical coding scheme may be coded in accordance with embodiments of the invention, i.e. utilising a tensor core. In this sense, a tensor core is thus not considered a traditional coding resource. Thus a first layer and a second layer can be coded in parallel (e.g. concurrently), thus increasing throughput and/or reducing latency. This is particularly advantageous for the hierarchical coding scheme known as MPEG-5 Part 2 LCEVC, where the ‘lowest’ layer is a base layer (a base layer coded with a single layer ‘separate coding scheme’ such as X264, VVC, HEVC, etc). In this example, the traditional coding resources are likely to be busy coding the base layer (more generally, resources such as general purpose GPU cores, may be busy performing tasks including but not limited to coding the base layer), therefore, it is advantageous for the coding of the LCEVC enhancement layers to be performed utilising tensor cores (because the tensor cores are unlikely to be busy). This means that described embodiments can be especially advantageous when used in combination with hierarchical coding schemes. Therefore, embodiments are particularly useful when the coding scheme is LCEVC and/or SMPTE VC-6, this is because they are both hierarchical schemes.

Some coding schemes (such as LCEVC and VC-6), achieve good compression despite not utilising interframe prediction such as motion prediction. Due to the purposeful non-utilisation of interframe prediction, frames (in a sequence of frames) can be coded independently of the coding of other frames in the sequence. This means embodiments provide even greater advantages when used for such coding schemes. This is because, a first frame could be coded using traditional coding resources and a second frame can be coded (e.g. concurrently) using embodiments of the invention (i.e. at least partly utilising a tensor core). This increases throughput and/or reduces latency because if a tensor core was not utilised then the second frame would not be coded until the traditional coding resources had finished coding the first frame, or more generally, fewer resources would be available to code the first and second frames and thus latency would generally be increased. Such advantages are generally not possible for coding schemes that utilise interframe prediction because the coding of the second frame may not be possible until the coding of the first frame has been completed, this is because the coding of the second frame may require an input from the coded first frame in order to perform the coding of the second frame.

Some coding schemes (such as LCEVC and VC-6), achieve good compression despite not utilising intraframe prediction. Due to the purposeful non-utilisation of intraframe prediction, coding units (and/or blocks and/or tiles) within a frame can be coded independently of one another. This means embodiments provide even greater advantages when used for such coding schemes. This is because, a first coding unit could be coded using traditional coding resources and a second coding unit can be coded (e.g. concurrently) using embodiments of the invention (i.e. utilising a tensor core). This increases throughput and/or reduces latency because if a tensor core was not utilised then the second coding unit would not be coded until the traditional coding resources had finished coding the first coding unit. Such advantages are generally not as possible for coding schemes that utilise intraframe prediction because the coding of the second coding unit may not be possible until the coding of the first coding unit has been completed, this is because the coding of the second coding unit may require an input from the coded first coding unit in order to perform the coding of the second coding unit.

This means that described embodiments can be especially advantageous when used in combination with coding schemes that do not utilise one or more of inter frame coding and intra frame coding techniques.

In short, it is especially advantageous to operate embodiments of the invention in combination with (highly) parallelisable coding schemes.

According to a further aspect there is provided a method of encoding and/or decoding a signal, the encoding/decoding comprising one or more tasks, the method comprising: instructing a first task to be performed by a first resource of a GPU, wherein the first resource is a tensor operation.

Preferably, by performing the task, input data is processed to generate output data, and the method comprises: modifying, prior to the tensor core commencing the first task, the input data to generate modified input data, so that the modified input data is compatible with requirements of the tensor operation. Preferably, the method comprises instructing the tensor operation to operate on the modified input data rather than the input data.

Preferably the method comprises flagging to the GPU that a tensor operation is to be used. Preferably the method comprises determining that input data is supported the tensor operation. Preferably the method comprises determining that input data is not supported the tensor operation, and in response, generating modified input data, wherein the modified input data is supported by the tensor operation.

Preferably, the method comprises, instructing a second task to be performed by a second resource of the GPU, wherein the second resource is a resource other than a tensor operation, in particular such that the first task and second task are performed in parallel.

Preferably, the method comprises instructing the first resource in response to determining that the second resource is busy. Busy may correspond to a work queue for the second resource above a threshold. Thus, preferably, the method comprises instructing the first resource in response to determining that a work queue for the second resource is above a threshold.

Preferably, the coding scheme is a hierarchical coding scheme. In particular, wherein the hierarchical coding scheme comprises a base layer and one or more enhancement layers. Preferably, wherein the first task and second task are tasks operating on different layers of the hierarchical coding scheme. In particular, wherein the coding of the enhancement layer comprises the first task and the coding of the base layer comprises the second task.

Preferably, the coding scheme is a coding scheme that does not utilise one or more of: interframe coding methods and intraframe coding methods. Intraframe coding methods may comprise intraframe prediction. Interframe coding methods may comprise one or more of interframe prediction, use of motion vectors, and the use of motion estimation.

Preferably the method may comprise signalling to the GPU to request that tensor operations be used for a task. The signalling may be achieved via: generation and/or signalling of metadata; and/or by a particular arrangement and/or modification of the input data.

Although references to a tensor operation is generally made. Embodiments may additionally or alternatively, instruct a tensor processing unit (such as Google's TPU). A TPU is a processing unit that only comprises tensor operation, and for example does not comprise general GPU cores such as CUDA cores.

According to a third aspect of the invention, there is provided a codec comprising one or more processors configured to perform the method of any preceding statement.

According to a fourth aspect of the invention, there is provided a computer readable storage medium comprising instructions, when executed by a processor, cause the processor to perform the method steps of any preceding statement.

According to a fifth aspect of the invention, there is provided a computer program comprising instructions, when executed by a processor, cause the processor to perform the method steps of any preceding statement.

### BRIEF DESCRIPTION OF THE DRAWINGS

The invention shall now be described, by way of example only, with reference to the accompanying drawings in which:

FIG. 1 shows a block diagram representing how a GPU can process a convolutional filtering operation as an example;

FIG. 2 shows a block diagram representing how a GPU can process a convolutional filtering operation using tensor cores according to an aspect of the invention;

FIG. 3 is a flowchart outlining a method according to an aspect of the invention; and

FIG. 4 is a flowchart outlining a method according to another aspect of the invention.

### DETAILED DESCRIPTION

### Filtering and Image Processing Using Kernels

An input image can be processed into an output image by convolving an input matrix representing the input image (or a part thereof) with a kernel to produce an output matrix.

Convolution is the process of adding each element of the image to its local neighbours, weighted by the kernel. This is related to a form of mathematical convolution. The matrix operation being performed (convolution) is not traditional matrix multiplication, despite being similarly denoted by *.

To illustrate, an example is given below where iᵢⱼ are elements of the input matrix and kᵢ are elements of the kernel, and where oᵢⱼ are elements of the output matrix.

$$[ \begin{matrix}{i}_{00} & {i}_{01} & {i}_{02} & {i}_{03} & {i}_{04} \\ {i}_{10} & {i}_{11} & {i}_{12} & {i}_{13} & {i}_{14} \\ {i}_{21} & {i}_{21} & {i}_{22} & {i}_{23} & {i}_{24} \\ {i}_{30} & {i}_{31} & {i}_{32} & {i}_{33} & {i}_{34} \\ {i}_{40} & {i}_{41} & {i}_{42} & {i}_{43} & {i}_{44}\end{matrix} ] * [ {k}_{0} {k}_{1} {k}_{2} ] = [ \begin{matrix}{o}_{00} & {o}_{01} & {o}_{02} & {o}_{03} & {o}_{04} \\ {o}_{10} & {o}_{11} & {o}_{12} & {o}_{13} & {o}_{14} \\ {o}_{20} & {o}_{21} & {o}_{22} & {o}_{23} & {o}_{24} \\ {o}_{30} & {o}_{31} & {o}_{32} & {o}_{33} & {o}_{34} \\ {o}_{40} & {o}_{41} & {o}_{42} & {o}_{43} & {o}_{44}\end{matrix} ]$$

o₀₀=(i₀₋₁×k₀)+(i₀₀×k₁)+(i₀₁×k₂); o₀₁=(i₀₀×k₀)+(i₀₁×k₁)+(i₀₂×k₂) etc. is as is known in the art of convolution (here, it is useful to think that the kernel acts like a “sliding window” across each row of the input data). In the above example, image edges can be handled using techniques (extend, wrap, mirror, crop/avoid overlap, kernel crop, constant) that are known in the art to create the output matrix. In some techniques, such as that shown above, a 5×5 output matrix is derived using for example the extend technique. If the crop/avoid overlap technique is used a 5×3 matrix would be derived instead.

The convolutional filtering operation can be used for downsampling or upsampling of the input data in the input matrix. Downsampling can be achieved in 1D, for example, by applying the filter kernel with two consecutive data points in each row of the input matrix as centre points, which outputs a single data point, thus computing a smaller number of output data points accordingly (e.g., W/2). For 2D downsampling, the output data achieved from the 1D downsampling may be transposed so that the columns become rows and the kernel convolution applied again (e.g., this effectively achieves H/2). The final output data can be transposed as needed e.g., so that the rows become columns to rearrange the downsampled data to be consistent with the input data.

The above processes are defined as convolutional filtering operations and may be performed using a CPU or a GPU.

### Utilising a GPU

Such convolutional filtering operations can be performed on a GPU.

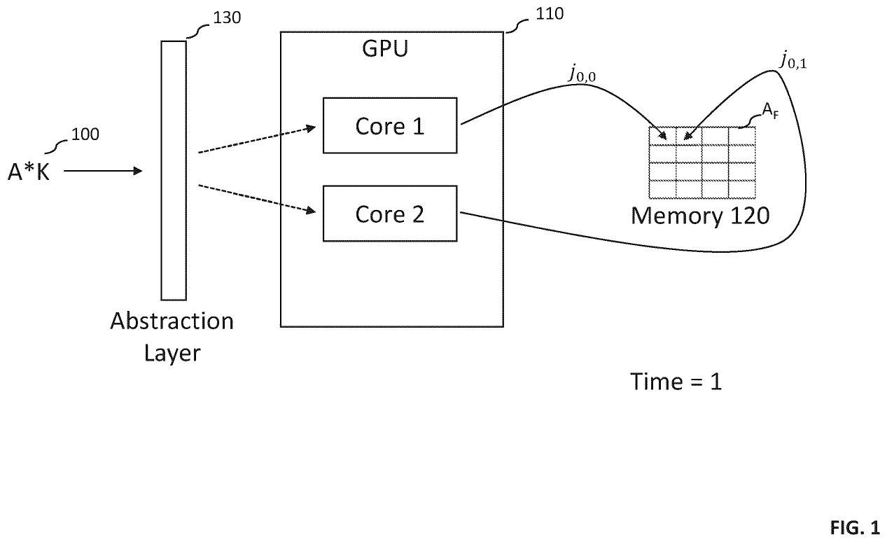

FIG. 1 shows a block diagram representing how a GPU can process a convolutional filtering operation as an example.

In general, this can be done by loading an input frame (A) into a memory, loading a kernel (K) into a memory, specifying an operation 100 (e.g., convolution A*K) for a GPU 110, and instructing the GPU 110 on where and how to store the output A_{F}. Output A_{F} is stored in this example in memory 120. The instruction/kernel/shader 100 (we will use these terms interchangeably from here on) can be laid out in a way that independent output can be calculated in parallel on related sets of inputs. Also, the GPU can be instructed to utilise different resources within the GPU to perform this task.

There is usually an abstraction layer 130 before the GPU hardware operations. For example Vulkan is a GPU vendor agnostic interface/API that takes an operation or desired outcome and translates this into an intermediate representation. This then can be translated to low-level vendor hardware specific instructions by the compilers maintained by the vendors of the GPUs themselves.

It is mostly possible to instruct the GPU exactly how to carry out an operation and with what resource. In certain cases however, when a particular resource is vendor specific and the API used to drive the GPU is vendor agnostic, a feature to help a user drive that resource is often exposed as an API extension. In a simplified description, this API extension takes more generic inputs and instructions about the operation to be performed and converts them to more detailed, vendor-specific and resource-specific instructions in low-level code, which the compiler takes care of, when dedicated resource is available from a GPU vendor. For some GPUs, where the GPU vendors do not provide a dedicated resource for such operations, the GPUs handle these requests in the best way that suits their hardware configuration, ‘under the hood’ and return the desired output.

Sometimes, more than one resource on a particular GPU can be used to do the same operation. The GPU can be instructed to use either resource.

### GPU Cores for General-Purpose Parallel Computing

GPU cores are commonly used for general-purpose parallel computing. Generally a GPU has multiple such general-purpose computing cores. Each general-purpose computing core would normally have a fully pipelined integer arithmetic logic unit (ALU) and a floating point unit (FPU).

Each GPU core can execute one operation per clock cycle. These GPU cores accelerate computation by executing instructions in parallel in SIMT (Single Instruction Multiple Threads) fashion. In a first comparative example, a GPU is instructed in a first manner with few details or requirements. In this example, the GPU may use ‘CUDA cores’ (e.g. core 1 and core 2, although in reality the number of cores utilised will be much larger) to generate the outcome A_{F}. At a first time, i.e. t=1, each core is utilised to calculate a single value, in this case j_{0,0} and j_{0,1}. These calculated values are then saved in memory, where an (incomplete, or at time=0, an empty) output matrix is stored in memory 120. At a second time, t=2, each core calculates a further value each, e.g. core 1 calculates j_{0,2} and core 2 calculates j_{0,3}. These values are then stored in output matrix A_{F} in the memory 120. This continues until all of the values of the output matrix are calculated and stored or output.

The instruction, typically within a shader, may include details on where and how each output value (e.g. j_{0,0}, j_{0,1}) is written to in memory, or the corresponding API or low level code may determine the output memory locations based on the instruction (e.g. if a convolution is instructed, then the API or low level code will save successive outputs in appropriate locations). This may be relatively simple in this first method, as each core only outputs a single value. In one example, when a single value is generated in a single thread, the output memory location is based on the thread index.

Generally, once the output matrix is completed, the output matrix is transmitted back to the user, e.g. via the abstraction layer 130. This method of processing by the GPU 110 can be seen as a ‘default’ method because the CUDA cores are very good at general purpose calculations and so can serve almost any request made of the GPU.

Whilst this works fine most of the time, e.g. it can process values quickly enough, the inventors have developed an alternative improved approach.

### Tensor Cores

Tensor cores specialise in matrix multiplications and are known to be very useful for training and inferencing of neural networks.

Tensor cores perform the following operation:

$$D = A \times B + C$$

where A is a matrix having dimensions M×K, B is a matrix having dimensions K×N and C/D are matrices having dimensions M×N.

Each tensor core can perform 64 FMA operations in a single clock cycle, equivalent to 64 threads doing this parallelly on CUDA cores.

Each implementation (driver+architecture) has limitations in terms of data types and matrix sizes that is supported, and these can be queried at runtime for example as a part of a Vulkan cooperative matrix extension. Typically, the following matrix sizes are supported (M, N, K): 16, 16, 16; 16, 8, 16; 16, 8, 8; 16, 16, 32; 16, 8, 32; and 8, 8, 32.

Tensor cores are one example of specialised cores that enable mixed precision computing for machine learning training and inferencing. They are provided on GPUs.

As shown above, tensor cores are programmable matrix-multiply-and-accumulate units that can deliver very high throughput for mixed precision calculations.

Moreover, in known image encoding/decoding implementations, tensor cores are not used. Therefore the tensor cores are an unutilised resource during image decoding/encoding.

Thus, if some of the image encoding/decoding processes can be offloaded to the tensor core, this will increase throughput and/or decrease latency because some of the workload that was previously performed via other resources (e.g. with CUDA cores or by the CPU) is now offloaded to the tensor cores. Thus, if the tensor core workload can be done in parallel with the other workloads, then the overall time to perform a decoding/encoding task will be shorter than if the tensor cores were not utilised.

In other words, latency can be decreased because the tensor cores can work on operations whilst the other resources (e.g. CUDA cores or CPU) are working on other parts of the coding pipeline. It can also be seen as more efficient resource utilisation. The advantages are particularly useful in coding schemes where parts, and especially but not exclusively significant parts, of the coding pipeline can be performed in parallel, such as LCEVC coding described below. LCEVC modules can take advantage of tensor cores or equivalents, especially for filtering and sampling operations.

The inventors have had the insight to try to utilise tensor cores or equivalent resources such as an Intelligence Processing Unit for image coding operations. Resources configured for machine learning processing, such as the tensor cores available in modern Nvidia® GPUs, are seen as being useful and potential candidates for use. The techniques developed by the inventors will be described below. Although, the disclosure herein uses image coding operations to outline the invention, similar technique can also be applied to other types of encoding/decoding operations such as encoding/decoding of volumetric data (such as point cloud data, mesh data, and so forth), audio data, and other digital data.

### Tensor Core Signalling

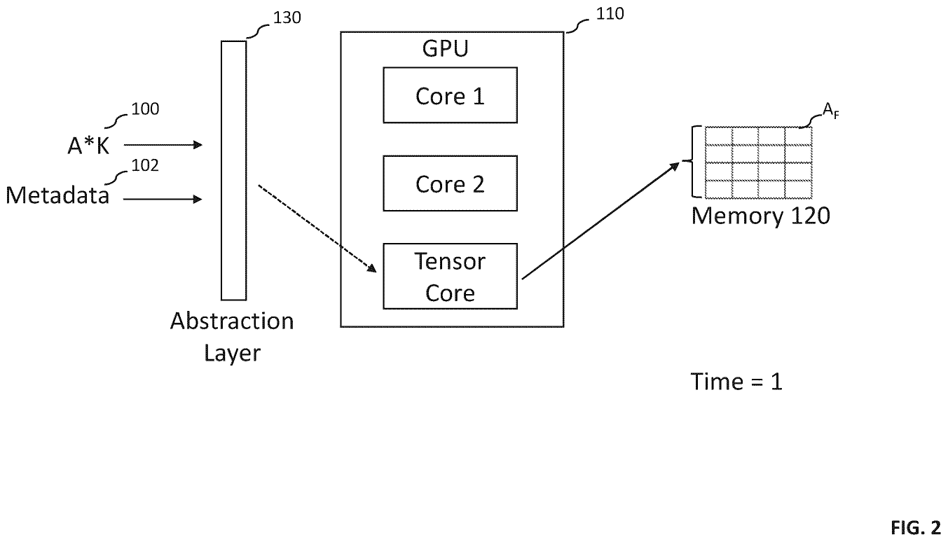

FIG. 2 shows a block diagram representing how a GPU can process a convolutional filtering operation using tensor cores as an example. Like reference signs are used to donate like references vis-à-vis FIG. 1.

In the example of FIG. 2, metadata 102 is used to instruct the abstraction layer 130 to use tensor cores for the instructed convolution of A and K via instruction 100.

In this way the GPU 110 processes the output matrix A_{F} differently when utilising tensor cores compared to the first comparative method described above in relation to FIG. 1 (i.e. when using CUDA cores). This metadata 102 helps ensure that the GPU 110 uses the tensor cores to perform the calculation, rather than using CUDA cores 1 and cores 2, as necessary. Although in FIG. 2 the instruction 100 (A*K) and metadata 102 are shown as being input separately into the abstraction data, this is for visual explanation. Instead, what may be input into the abstraction layer 130 may be a ‘different’ instruction for A*F, i.e. in a different format and/or different details to the instruction of A*F as shown in the first example. The difference in the way that the abstraction layer is instructed (cf the first comparative example of FIG. 1) means that the GPU 130 utilises the tensor core(s), rather than the CUDA core 1 and core 2. In other words, while metadata is one way of signalling the use of tensor cores, other ways may be used to signal the use of tensor cores, such as using a different or particular instruction.

A key difference (cf. to a CUDA core) is that a (e.g. single) tensor core outputs a matrix, rather than an individual value each clock cycle.

In this example, a tensor core can output a 4×4 matrix A_{F} (and is instructed to do so), and the original request was for a 4×4 matrix (A_{F}), so the tensor core is able to produce the output in one clock cycle.

In other examples, the required output matrix may be a 16×16 (or larger), and so the tensor core would need to perform 4 cycles to complete the request of a 16×16 matrix (or 4 tensor cores can be instructed to work in parallel). Incidentally, in such an example, the first ‘CUDA core’ method would require 128 cycles because 256 values are needed and 2 CUDA cores are used.

Such numbers are exemplary only, in reality, a GPU may have 10, 100, 1000, 10000 or more CUDA cores. Moreover, a GPU may have 10, 100, 1000, 10000 or more tensor cores. Also, as explained below, tensor cores may be able to take in as input and output matrices larger than 4×4s, as mentioned above.

When creating or programming a filtering process to be executable by a CPU, GPU, CUDA CORE or TENSOR CORE, certain parameters/configurations must be in place to allow the process to be able to use the resource that is most appropriate at that time, e.g. use CUDA COREs when available, or use TENSOR COREs when the CUDA COREs are in use.

As an example, some operations are used to specify/alter the input data and kernel configurations when calling for a CUDA CORE to perform the filtering/sampling operation.

In another example, a simulation is run to decide which resource to use given an input data, kernel, and knowledge of existing resource usage and availability. Based on the simulation the CPU/GPU will then know how to make the input data and kernel compliant with the TENSOR CORES in the following described ways so that the TENSOR CORES are instructed.

### Filtering by Matrix Multiplication

Filtering can be performed by matrix multiplication. The matrix multiplication may usefully be performed on GPUs using cooperative matrix extensions as found on the Vulkan implementation using tensor cores, for example. Cooperative matrix types are medium-sized matrices that are primarily supported in compute shaders, where the storage for the matrix is spread across all invocations in some scope (usually a subgroup) and those invocations cooperate to efficiently perform matrix multiplies.

To offload the operation to the tensor cores, significant modifications to the usual process (e.g., including but not limited to modification of the instruction of the calculation, and modification to the input matrices) have been needed requiring significant work from the inventors. In particular, the inventors have realised that you can create a ‘tensor core filtering matrix’ K_{M} that, when multiplied with A, gives you the filtered input A_{F}.

### Overcoming Matrix Size Limitations

Each implementation of tensor cores (driver+architecture) has limitations in terms of matrix sizes that are supported and these can be queried at runtime as a part of the Vulkan cooperative matrix extension.

This means trying to fit the input, kernel and output matrix sizes around them with an emphasis on fitting the input and kernel matrix sizes.

In exemplary embodiments, the input data and kernel data are arranged in the correct size to suit the implementation accordingly.

In theory, this sounds possible. However, in practice, since tensor cores are for mixed precision training, these only accept matrices with specific features (MATRIX_{DIMS}, DATA TYPE, ETC) as inputs.

This gives rise to a challenge because of a kernel matrix dimensions (N×K) limitation. Practical implementation can easily run out of space due to kernel size being too large for an available kernel matrix. This is due to a potential mismatch between the number of kernel coefficients (e.g., k₁, k₂ . . . k₁₂) and the number of rows (N) and columns (K) needed in a kernel matrix. This is because the kernel coefficients are transposed to be positioned vertically in a column in the kernel matrix K_{M}. Thus, for more kernel coefficients a larger number of rows is needed in the kernel matrix K_{M} to accommodate the kernel coefficients. The larger number of rows is because the vertical kernel coefficients in subsequent columns of the kernel matrix move “down” in the kernel matrix K_{M} (by adding one or more zeros at the top of each subsequent column) to achieve a sliding window effect needed for consecutive convolution outputs in a particular row. Ten or more (e.g. twelve) kernel coefficients are sometimes needed and, in such scenarios, it is easy to run out of space in the kernel matrix if there is a size limitation such as a commonly known limitation of a 16×16 matrix.

For example, to illustrate how this works in theory a 1D kernel may have a single coefficient e.g., having a value of 2. The kernel may be modified to form a 4×4 kernel matrix for multiplication with a 4×4 image matrix, as follows:

$$[ \begin{matrix}1 & 2 & 3 & 4 \\ 5 & 6 & 7 & 8 \\ 9 & 10 & 11 & 12 \\ 13 & 14 & 15 & 16\end{matrix} ] [ \begin{matrix}2 & 0 & 0 & 0 \\ 0 & 2 & 0 & 0 \\ 0 & 0 & 2 & 0 \\ 0 & 0 & 0 & 2\end{matrix} ] = [ \begin{matrix}2 & 4 & 6 & 8 \\ 10 & 12 & 14 & 16 \\ 18 & 20 & 22 & 24 \\ 26 & 28 & 30 & 32\end{matrix} ]$$

As shown above, the kernel matrix did not run out of space and a full output matrix is provided. However, in another example, a 1D kernel may have two coefficients e.g., each having a value of 2. The 1D kernel may be modified to form a 4×4 kernel matrix for multiplication with a 4×4 image matrix. In this example, the 4×4 kernel matrix cannot accommodate the kernel as the kernel matrix runs out of space (i.e., there needs to be a fifth row). As a result of the sparse kernel matrix an incomplete output is produced as follows (i.e., the fourth column is filled with zeros):

$$[ \begin{matrix}1 & 2 & 3 & 4 \\ 5 & 6 & 7 & 8 \\ 9 & 10 & 11 & 12 \\ 13 & 14 & 15 & 16\end{matrix} ] [ \begin{matrix}2 & 0 & 0 & 0 \\ 2 & 2 & 0 & 0 \\ 0 & 2 & 2 & 0 \\ 0 & 0 & 2 & 0\end{matrix} ] = [ \begin{matrix}6 & 10 & 14 & 0 \\ 22 & 26 & 30 & 0 \\ 38 & 42 & 46 & 0 \\ 54 & 58 & 62 & 0\end{matrix} ]$$

In another example to illustrate a kernel matrix running out of space for the kernel, in the case of a 1D operation, a kernel matrix size is limited to a typical size of 16×8 (=K×N, where K is the height of the kernel matrix (i.e., number of rows) and N is the width (i.e., number of columns)). With a 1D kernel having 12 coefficients, the kernel matrix will only be able to represent the kernel being moved 5 times. This is shown in the kernel matrix below where k_{0B} is at the bottom of the kernel matrix at the fifth column. Shifting the kernel coefficients down in the sixth column would result in the final coefficient k_{0B} being lost from the kernel matrix and data errors would result in any output. Note that K matches K of the input matrix (i.e., the width or number of columns of the input matrix=16.

$$[ \begin{matrix}{k}_{00} & 0 & 0 & 0 & 0 & 0 & 0 & 0 \\ {k}_{01} & {k}_{00} & 0 & 0 & 0 & 0 & 0 & 0 \\ {k}_{02} & {k}_{01} & {k}_{00} & 0 & 0 & 0 & 0 & 0 \\ {k}_{03} & {k}_{02} & {k}_{01} & {k}_{00} & 0 & 0 & 0 & 0 \\ {k}_{04} & {k}_{03} & {k}_{02} & {k}_{01} & {k}_{00} & 0 & 0 & 0 \\ {k}_{05} & {k}_{04} & {k}_{03} & {k}_{02} & {k}_{01} & 0 & 0 & 0 \\ {k}_{06} & {k}_{05} & {k}_{04} & {k}_{03} & {k}_{02} & 0 & 0 & 0 \\ {k}_{07} & {k}_{06} & {k}_{05} & {k}_{04} & {k}_{03} & 0 & 0 & 0 \\ {k}_{08} & {k}_{07} & {k}_{06} & {k}_{05} & {k}_{04} & 0 & 0 & 0 \\ {k}_{09} & {k}_{08} & {k}_{07} & {k}_{06} & {k}_{05} & 0 & 0 & 0 \\ {k}_{0 A} & {k}_{09} & {k}_{08} & {k}_{07} & {k}_{06} & 0 & 0 & 0 \\ {k}_{0 B} & {k}_{0 A} & {k}_{09} & {k}_{08} & {k}_{07} & 0 & 0 & 0 \\ 0 & {k}_{0 B} & {k}_{0 A} & {k}_{09} & {k}_{08} & 0 & 0 & 0 \\ 0 & 0 & {k}_{0 B} & {k}_{0 A} & {k}_{09} & 0 & 0 & 0 \\ 0 & 0 & 0 & {k}_{0 B} & {k}_{0 A} & 0 & 0 & 0 \\ 0 & 0 & 0 & 0 & {k}_{0 B} & 0 & 0 & 0\end{matrix} ]$$

In yet another example to illustrate a kernel matrix running out of space for the kernel, in the case of a 1D horizontal downsample operation (since the output samples will be half the input samples and centre pixels for convolution are moved by 2 horizontally in the input matrix), a kernel matrix size is limited to a typical size of 16×8 (=K×N, where N is the width (i.e., number of columns) of the kernel matrix and K is the height of the kernel matrix (i.e., number of rows)). With a kernel having 12 coefficients, the kernel matrix will only be able to represent the kernel being moved 3 times because the 1D kernel is moved down by two values in each successive column of the kernel matrix. This is shown in the kernel matrix below where k_{0B} is at the bottom of the kernel matrix at the third column. Shifting the kernel coefficients down in the fourth column would result in the final two coefficients k_{0A} and k_{0B} being lost from the kernel matrix and data errors would result in any output. The kernel matrix below has a size of K×N, where K is of the same size as K of the input matrix (i.e., 16) and N has a size of 8 which is derived from the input matrix have K dimension and the scaling factor 2 (i.e., 16/2=8).

$$[ \begin{matrix}{k}_{00} & 0 & 0 & 0 & 0 & 0 & 0 & 0 \\ {k}_{01} & 0 & 0 & 0 & 0 & 0 & 0 & 0 \\ {k}_{02} & {k}_{00} & 0 & 0 & 0 & 0 & 0 & 0 \\ {k}_{03} & {k}_{01} & 0 & 0 & 0 & 0 & 0 & 0 \\ {k}_{04} & {k}_{02} & {k}_{00} & 0 & 0 & 0 & 0 & 0 \\ {k}_{05} & {k}_{03} & {k}_{01} & 0 & 0 & 0 & 0 & 0 \\ {k}_{06} & {k}_{04} & {k}_{02} & 0 & 0 & 0 & 0 & 0 \\ {k}_{07} & {k}_{05} & {k}_{03} & 0 & 0 & 0 & 0 & 0 \\ {k}_{08} & {k}_{06} & {k}_{04} & 0 & 0 & 0 & 0 & 0 \\ {k}_{09} & {k}_{07} & {k}_{05} & 0 & 0 & 0 & 0 & 0 \\ {k}_{0 A} & {k}_{08} & {k}_{06} & 0 & 0 & 0 & 0 & 0 \\ {k}_{0 B} & {k}_{09} & {k}_{07} & 0 & 0 & 0 & 0 & 0 \\ 0 & {k}_{0 A} & {k}_{08} & 0 & 0 & 0 & 0 & 0 \\ 0 & {k}_{0 B} & {k}_{09} & 0 & 0 & 0 & 0 & 0 \\ 0 & 0 & {k}_{0 A} & 0 & 0 & 0 & 0 & 0 \\ 0 & 0 & {k}_{0 B} & 0 & 0 & 0 & 0 & 0\end{matrix} ]$$

The inventors determined that this problem can be solved by populating the remaining columns of the kernel matrix (i.e. column 6 onwards in the non-downsampling example and column 4 onwards in the downsampling example) with zero values. However, this means that unfortunately the output matrix will only have 5 or 3 columns respectively of useful or valid (i.e. non-zero values) in the above two examples.

To the skilled person, it would seem counter-intuitive to do ‘extra’ calculations (i.e. the zero multiplications) and thus they would not consider instructing the calculation to be done in this way using for example a tensor core.

This sparse kernel matrix is not the best in computational efficiency and throughput as more invocation/matrix multiplications need to be made to fill the whole output as opposed to a less sparse kernel matrix which gives more valid output values with each invocation/matrix multiplication operation.

There are additional techniques disclosed which further contribute to the solution above, by selecting an input matrix A to have a size which is efficient to process and by selecting a suitable kernel matrix size and arranging the kernel coefficients therein efficiently.

### Example 1: Gaussian Blur

An input image can be processed into an output image by convolving an input matrix i representing the input image (or a part thereof) with a kernel, such as in this example a 1×3 1D kernel k=[k₀ k₁ k₂] to produce an output matrix o representing a processed image. The kernel k can be, for example, a 1D horizontal separable kernel derived from a 3×3 2D kernel representing a Gaussian blurring operation to take advantage of separable convolution.

Convolution is the process of adding each element of the image to its local neighbours, weighted by the kernel. This is related to a form of mathematical convolution. The matrix operation being performed (convolution) is not traditional matrix multiplication, despite being similarly denoted by *.

An example is given below.

$$[ \begin{matrix}{i}_{00} & {i}_{01} & {i}_{02} & {i}_{03} & {i}_{04} \\ {i}_{10} & {i}_{11} & {i}_{12} & {i}_{13} & {i}_{14} \\ {i}_{21} & {i}_{21} & {i}_{22} & {i}_{23} & {i}_{24} \\ {i}_{30} & {i}_{31} & {i}_{32} & {i}_{33} & {i}_{34} \\ {i}_{40} & {i}_{41} & {i}_{42} & {i}_{43} & {i}_{44}\end{matrix} ] * [ {k}_{0} {k}_{1} {k}_{2} ] = [ \begin{matrix}{o}_{00} & {o}_{01} & {o}_{02} & {o}_{03} & {o}_{04} \\ {o}_{10} & {o}_{11} & {o}_{12} & {o}_{13} & {o}_{14} \\ {o}_{20} & {o}_{21} & {o}_{22} & {o}_{23} & {o}_{24} \\ {o}_{30} & {o}_{31} & {o}_{32} & {o}_{33} & {o}_{34} \\ {o}_{40} & {o}_{41} & {o}_{42} & {o}_{43} & {o}_{44}\end{matrix} ]$$

Where o₀₀=(i₀₋₁×k₀)+(i₀₀×k₁)+(i₀₁×k₂) etc is as is known in the art of convolution. In the above example, image edges are handled using techniques (extend, wrap, mirror, crop/avoid overlap, kernel crop, constant) that are known in the art to create an output matrix from a 5×5 input matrix. In some techniques, such as that shown above, a 5×5 output matrix is derived. A 5×3 matrix would be derived if the crop/avoid overlap technique is used which would result in the following output:

$$[ \begin{matrix}{o}_{00} & {o}_{01} & {o}_{02} \\ {o}_{10} & {o}_{11} & {o}_{12} \\ {o}_{20} & {o}_{21} & {o}_{22} \\ {o}_{30} & {o}_{31} & {o}_{32} \\ {o}_{40} & {o}_{41} & {o}_{42}\end{matrix} ]$$

For matrix multiplication, a kernel matrix can be created from the 1D Gaussian kernel k by creating a transposed matrix, as shown below, which is a type of modified Toeplitz or circulant matrix:

$$[ \begin{matrix}{k}_{0} & 0 & 0 \\ {k}_{1} & {k}_{0} & 0 \\ {k}_{2} & {k}_{1} & {k}_{0} \\ 0 & {k}_{2} & {k}_{1} \\ 0 & 0 & {k}_{2}\end{matrix} ]$$

The input matrix can then be multiplied with the kernel matrix to derive an output matrix.

$$[ \begin{matrix}{i}_{00} & {i}_{01} & {i}_{02} & {i}_{03} & {i}_{04} \\ {i}_{10} & {i}_{11} & {i}_{12} & {i}_{13} & {i}_{14} \\ {i}_{21} & {i}_{21} & {i}_{22} & {i}_{23} & {i}_{24} \\ {i}_{30} & {i}_{31} & {i}_{32} & {i}_{33} & {i}_{34} \\ {i}_{40} & {i}_{41} & {i}_{42} & {i}_{43} & {i}_{44}\end{matrix} ] [ \begin{matrix}{k}_{0} & 0 & 0 \\ {k}_{1} & {k}_{0} & 0 \\ {k}_{2} & {k}_{1} & {k}_{0} \\ 0 & {k}_{2} & {k}_{1} \\ 0 & 0 & {k}_{2}\end{matrix} ] = [ \begin{matrix}{o}_{00} & {o}_{01} & {o}_{02} \\ {o}_{10} & {o}_{11} & {o}_{12} \\ {o}_{20} & {o}_{21} & {o}_{22} \\ {o}_{30} & {o}_{31} & {o}_{32} \\ {o}_{40} & {o}_{41} & {o}_{42}\end{matrix} ]$$

In this example, a 5×3 output matrix is derived, where o₀₀=(i₀₀×k₀)+(i₀₁×k₁)+(i₀₂×k₂)+(i₀₃×0)+(i₀₄×0) etc. A skilled person would now understand how to structure the input data appropriately in multiple input matrices to process all the input data as required to result in the same output data that would be derived from the convolutional filtering operation that is desired.

Of course the output dimensions are affected by the input dimensions of the input matrices.

$${A}_{M \times K} \times {B}_{K \times N} = {C}_{M \times N}$$

Also note if this operation had limitation on the matrix dimensions this might result into a very sparse kernel and subsequently sparse output matrix.

In this example, for 1D convolution, the kernel is modified to be a non-square transposed sparse circulant matrix without the need to modify the input.

### Example 2: 1D 12-Tap Convolution Downsample

$$Kernel : [ {k}_{0} {k}_{1} {k}_{2} {k}_{3} {k}_{4} {k}_{5} {k}_{6} {k}_{7} {k}_{8} {k}_{9} {k}_{10} {k}_{11} ]$$

$$[ \begin{matrix}{i}_{00} & {i}_{01} & {i}_{02} & {i}_{03} & {i}_{04} & {i}_{05} & {i}_{06} & {i}_{07} & {i}_{08} & {i}_{09} & {i}_{0 A} & {i}_{0 B} \\ {i}_{10} & {i}_{11} & {i}_{12} & {i}_{13} & {i}_{14} & {i}_{15} & {i}_{16} & {i}_{17} & {i}_{18} & {i}_{19} & {i}_{1 A} & {i}_{1 B} \\ {i}_{20} & {i}_{21} & {i}_{22} & {i}_{23} & {i}_{24} & {i}_{25} & {i}_{26} & {i}_{27} & {i}_{28} & {i}_{29} & {i}_{2 A} & {i}_{2 B} \\ {i}_{30} & {i}_{31} & {i}_{32} & {i}_{33} & {i}_{34} & {i}_{35} & {i}_{36} & {i}_{37} & {i}_{38} & {i}_{39} & {i}_{3 A} & {i}_{3 B} \\ {i}_{40} & {i}_{41} & {i}_{42} & {i}_{43} & {i}_{44} & {i}_{45} & {i}_{46} & {i}_{47} & {i}_{48} & {i}_{49} & {i}_{4 A} & {i}_{4 B} \\ {i}_{50} & {i}_{51} & {i}_{52} & {i}_{53} & {i}_{54} & {i}_{55} & {i}_{56} & {i}_{57} & {i}_{58} & {i}_{59} & {i}_{5 A} & {i}_{5 B} \\ {i}_{60} & {i}_{61} & {i}_{62} & {i}_{63} & {i}_{64} & {i}_{65} & {i}_{66} & {i}_{67} & {i}_{68} & {i}_{69} & {i}_{6 A} & {i}_{6 B} \\ {i}_{70} & {i}_{71} & {i}_{72} & {i}_{73} & {i}_{74} & {i}_{75} & {i}_{76} & {i}_{77} & {i}_{78} & {i}_{79} & {i}_{7 A} & {i}_{7 B}\end{matrix} ] * [ {k}_{0} {k}_{1} {k}_{2} {k}_{3} {k}_{4} {k}_{5} {k}_{6} {k}_{7} {k}_{8} {k}_{9} {k}_{10} {k}_{11} ] = [ \begin{matrix}{o}_{00} & {o}_{01} & {o}_{02} & {o}_{03} & {o}_{04} & {o}_{05} \\ {o}_{10} & {o}_{11} & {o}_{12} & {o}_{13} & {o}_{14} & {o}_{15} \\ {o}_{20} & {o}_{21} & {o}_{22} & {o}_{23} & {o}_{24} & {o}_{25} \\ {o}_{30} & {o}_{31} & {o}_{32} & {o}_{33} & {o}_{34} & {o}_{35}\end{matrix} ]$$

For matrix multiplication, a kernel matrix is created from the 1D kernel by creating a transposed matrix, as below, with a horizontal downsampling by a factor of 2 (see the double zero in the top of the second column):

$$[ \begin{matrix}{k}_{00} & 0 & 0 & 0 & 0 & 0 & 0 & 0 \\ {k}_{01} & 0 & 0 & 0 & 0 & 0 & 0 & 0 \\ {k}_{02} & {k}_{00} & 0 & 0 & 0 & 0 & 0 & 0 \\ {k}_{03} & {k}_{01} & 0 & 0 & 0 & 0 & 0 & 0 \\ {k}_{04} & {k}_{02} & {k}_{00} & 0 & 0 & 0 & 0 & 0 \\ {k}_{05} & {k}_{03} & {k}_{01} & 0 & 0 & 0 & 0 & 0 \\ {k}_{06} & {k}_{04} & {k}_{02} & 0 & 0 & 0 & 0 & 0 \\ {k}_{07} & {k}_{05} & {k}_{03} & 0 & 0 & 0 & 0 & 0 \\ {k}_{08} & {k}_{06} & {k}_{04} & 0 & 0 & 0 & 0 & 0 \\ {k}_{09} & {k}_{07} & {k}_{05} & 0 & 0 & 0 & 0 & 0 \\ {k}_{0 A} & {k}_{08} & {k}_{06} & 0 & 0 & 0 & 0 & 0 \\ {k}_{0 B} & {k}_{09} & {k}_{07} & 0 & 0 & 0 & 0 & 0 \\ 0 & {k}_{0 A} & {k}_{08} & 0 & 0 & 0 & 0 & 0 \\ 0 & {k}_{0 B} & {k}_{09} & 0 & 0 & 0 & 0 & 0 \\ 0 & 0 & {k}_{0 A} & 0 & 0 & 0 & 0 & 0 \\ 0 & 0 & {k}_{0 B} & 0 & 0 & 0 & 0 & 0\end{matrix} ]$$

and usefully the input matrix is enlarged with input data where possible or padding to suit the size of the kernel matrix for tensor operations using operative matrices such that the relationship between the input matrix size and the kernel matrix is demonstrated as follows: the input matrix size is M×K and the kernel matrix size is K×N, wherein M is the height of the input matrix, N is the width of the kernel matrix and K is the width of the input matrix and the height of the kernel matrix. The enlarged input matrix is as follows:

$$[ \begin{matrix}{i}_{00} & {i}_{01} & {i}_{02} & {i}_{03} & {i}_{04} & {i}_{05} & {i}_{06} & {i}_{07} & {i}_{08} & {i}_{09} & {i}_{0 A} & {i}_{0 B} & {i}_{0 C} & {i}_{0 D} & {i}_{0 E} & {i}_{0 F} \\ {i}_{10} & {i}_{11} & {i}_{12} & {i}_{13} & {i}_{14} & {i}_{15} & {i}_{16} & {i}_{17} & {i}_{18} & {i}_{19} & {i}_{1 A} & {i}_{1 B} & {i}_{1 C} & {i}_{1 D} & {i}_{1 E} & {i}_{1 F} \\ {i}_{21} & {i}_{21} & {i}_{22} & {i}_{23} & {i}_{24} & {i}_{25} & {i}_{26} & {i}_{27} & {i}_{28} & {i}_{29} & {i}_{2 A} & {i}_{2 B} & {i}_{2 C} & {i}_{2 D} & {i}_{2 E} & {i}_{2 F} \\ {i}_{30} & {i}_{31} & {i}_{32} & {i}_{33} & {i}_{34} & {i}_{35} & {i}_{36} & {i}_{37} & {i}_{38} & {i}_{39} & {i}_{3 A} & {i}_{3 B} & {i}_{3 C} & {i}_{3 D} & {i}_{3 E} & {i}_{3 F} \\ {i}_{40} & {i}_{41} & {i}_{42} & {i}_{43} & {i}_{44} & {i}_{45} & {i}_{46} & {i}_{47} & {i}_{48} & {i}_{49} & {i}_{4 A} & {i}_{4 B} & {i}_{4 C} & {i}_{4 D} & {i}_{4 E} & {i}_{4 F} \\ {i}_{50} & {i}_{51} & {i}_{52} & {i}_{53} & {i}_{54} & {i}_{55} & {i}_{56} & {i}_{57} & {i}_{58} & {i}_{59} & {i}_{5 A} & {i}_{5 B} & {i}_{5 C} & {i}_{5 D} & {i}_{5 E} & {i}_{5 F} \\ {i}_{60} & {i}_{61} & {i}_{62} & {i}_{63} & {i}_{64} & {i}_{65} & {i}_{66} & {i}_{67} & {i}_{68} & {i}_{69} & {i}_{6 A} & {i}_{6 B} & {i}_{6 C} & {i}_{6 D} & {i}_{6 E} & {i}_{6 F} \\ {i}_{70} & {i}_{71} & {i}_{72} & {i}_{73} & {i}_{74} & {i}_{75} & {i}_{76} & {i}_{77} & {i}_{78} & {i}_{79} & {i}_{7 A} & {i}_{7 B} & {i}_{7 C} & {i}_{7 D} & {i}_{7 E} & {i}_{7 F} \\ {i}_{80} & {i}_{81} & {i}_{82} & {i}_{83} & {i}_{84} & {i}_{85} & {i}_{86} & {i}_{87} & {i}_{88} & {i}_{89} & {i}_{8 A} & {i}_{8 B} & {i}_{8 C} & {i}_{8 D} & {i}_{8 E} & {i}_{8 F} \\ {i}_{90} & {i}_{93} & {i}_{92} & {i}_{93} & {i}_{94} & {i}_{95} & {i}_{96} & {i}_{97} & {i}_{98} & {i}_{99} & {i}_{9 A} & {i}_{9 B} & {i}_{9 C} & {i}_{9 D} & {i}_{9 E} & {i}_{9 F} \\ {i}_{A 0} & {i}_{A 1} & {i}_{A 2} & {i}_{A 3} & {i}_{A 4} & {i}_{A 5} & {i}_{A 6} & {i}_{A 7} & {i}_{A 8} & {i}_{A 9} & {i}_{A A} & {i}_{AB} & {i}_{AC} & {i}_{A D} & {i}_{A E} & {i}_{AF} \\ {i}_{B 0} & {i}_{B 1} & {i}_{B 2} & {i}_{B 3} & {i}_{B 4} & {i}_{B 5} & {i}_{B 6} & {i}_{B 7} & {i}_{B 8} & {i}_{B 9} & {i}_{B A} & {i}_{B B} & {i}_{B C} & {i}_{B D} & {i}_{B E} & {i}_{B F} \\ {i}_{C 0} & {i}_{C 1} & {i}_{C 2} & {i}_{C 3} & {i}_{C 4} & {i}_{C 5} & {i}_{C 6} & {i}_{C 7} & {i}_{C 8} & {i}_{C 9} & {i}_{CA} & {i}_{C B} & {i}_{CC} & {i}_{CD} & {i}_{CE} & {i}_{C F} \\ {i}_{D 0} & {i}_{D 1} & {i}_{D 2} & {i}_{D 3} & {i}_{D 4} & {i}_{D 5} & {i}_{D 6} & {i}_{D 7} & {i}_{D 8} & {i}_{D 9} & {i}_{D A} & {i}_{D B} & {i}_{D C} & {i}_{D D} & {i}_{D E} & {i}_{D F} \\ {i}_{E 0} & {i}_{E 1} & {i}_{E 2} & {i}_{E 3} & {i}_{E 4} & {i}_{E 5} & {i}_{E 6} & {i}_{E 7} & {i}_{E 8} & {i}_{E 9} & {i}_{E A} & {i}_{E B} & {i}_{E C} & {i}_{ED} & {i}_{E E} & {i}_{E F} \\ {i}_{F 0} & {i}_{F 1} & {i}_{F 2} & {i}_{F 3} & {i}_{F 4} & {i}_{F 5} & {i}_{F 6} & {i}_{F 7} & {i}_{F 8} & {i}_{F 9} & {i}_{F A} & {i}_{F B} & {i}_{FC} & {i}_{F D} & {i}_{F E} & {i}_{FF}\end{matrix} ]$$

which when multiplied by the kernel matrix gives the following output:

$$[ \begin{matrix}{o}_{00} & {o}_{01} & {o}_{02} & 0 & 0 & 0 & 0 \\ {o}_{10} & {o}_{11} & {o}_{12} & 0 & 0 & 0 & 0 \\ {o}_{21} & {o}_{21} & {o}_{22} & 0 & 0 & 0 & 0 \\ {o}_{30} & {o}_{31} & {o}_{32} & 0 & 0 & 0 & 0 \\ {o}_{40} & {o}_{41} & {o}_{42} & 0 & 0 & 0 & 0 \\ {o}_{50} & {o}_{51} & {o}_{52} & 0 & 0 & 0 & 0 \\ {o}_{60} & {o}_{61} & {o}_{62} & 0 & 0 & 0 & 0 \\ {o}_{70} & {o}_{71} & {o}_{72} & 0 & 0 & 0 & 0 \\ {o}_{80} & {o}_{81} & {o}_{82} & 0 & 0 & 0 & 0 \\ {o}_{90} & {o}_{93} & {o}_{92} & 0 & 0 & 0 & 0 \\ {o}_{A 0} & {o}_{A 1} & {o}_{A 2} & 0 & 0 & 0 & 0 \\ {o}_{B 0} & {o}_{B 1} & {o}_{B 2} & 0 & 0 & 0 & 0 \\ {o}_{C 0} & {o}_{C 1} & {o}_{C 2} & 0 & 0 & 0 & 0 \\ {o}_{D 0} & {o}_{D 1} & {o}_{D 2} & 0 & 0 & 0 & 0 \\ {o}_{E 0} & {o}_{E 1} & {o}_{E 2} & 0 & 0 & 0 & 0 \\ {o}_{F 0} & {o}_{F 1} & {o}_{F 2} & 0 & 0 & 0 & 0\end{matrix} ]$$

Owing to the sparsity of the kernel matrix, useful data is populated in three columns of the output matrix. Full output data that corresponds to an input matrix when convolved with the kernel can be obtained by repeating this process with the same kernel matrix and a second input matrix that starts at a corresponding position (for example at column 6 in this example). Usually, a given input matrix represents only part of an image or picture to be processed and the given input matrices represent a sliding window across the input data to achieve corresponding output data.

Having said this, in an exemplary practical embodiment (e.g. a lanczos3 kernel in LCEVC which downsamples by a factor of 2 or other downsampling filters such as Area (2×2), lanczos(1×8), lanczos2(1×8), lanczos3(1×12) and larea3(1×12)), the pixels multiplied with k₀₅ and k₀₆ are the centre pixels and that is where the outputs will be written in the output file. All the pixels before these (those multiplied with k₀₀ to k₀₄) and after these (k₀₇ to k_{0B}) are spatially local pixel data considered with reduced weights or even negative weights. Here are the actual lanczos3 kernel coefficients to give a better idea [60, 247, −557, −1092, 2220, 7314, 7314, 2220, −1092, −557, 247, 60].

A horizontal pass of the manner described above will produce an output of W/2×H dimensions for an input of W×H dimensions. This will then be followed by a vertical downscaling with input W/2×H (from the horizontal downscaling) to produce the final downscaled output with dimensions W/2×H/2.

In an exemplary practical embodiment, vertical downscale is done in the same manner as the horizontal one just the input is read to the (input) matrix in a transposed manner.

In this example, for 1D convolution, the kernel is modified to be like a transposed sparse circulant matrix without the need to modify the input.

### Example 3: 2D Filtering

2D filtering might reduce the sparsity of a kernel and the output.

However, the input and output likely need to be re-arranged for the operation to fit a single matrix multiplication.

For example for a 2×2 2D kernel:

$$[ \begin{matrix}{i}_{00} & {i}_{01} & {i}_{02} & {i}_{03} & {i}_{04} & {i}_{05} & {i}_{06} \\ {i}_{10} & {i}_{11} & {i}_{12} & {i}_{13} & {i}_{14} & {i}_{15} & {i}_{16} \\ {i}_{20} & {i}_{21} & {i}_{22} & {i}_{23} & {i}_{24} & {i}_{25} & {i}_{26} \\ {i}_{30} & {i}_{31} & {i}_{32} & {i}_{33} & {i}_{34} & {i}_{35} & {i}_{36} \\ {i}_{40} & {i}_{41} & {i}_{42} & {i}_{43} & {i}_{44} & {i}_{45} & {i}_{46}\end{matrix} ] * [ \begin{matrix}{k}_{00} & {k}_{01} \\ {k}_{10} & {k}_{11}\end{matrix} ] = [ \begin{matrix}{o}_{00} & {o}_{01} & {o}_{02} & {o}_{03} & {o}_{04} & {o}_{05} \\ {o}_{10} & {o}_{11} & {o}_{12} & {o}_{13} & {o}_{14} & {o}_{15} \\ {o}_{21} & {o}_{21} & {o}_{22} & {o}_{23} & {o}_{24} & {o}_{25} \\ {o}_{30} & {o}_{31} & {o}_{32} & {o}_{33} & {o}_{34} & {o}_{35}\end{matrix} ]$$

where:

$${o}_{00} = ( {i}_{00} \times {k}_{00} ) + ( {i}_{01} \times {k}_{01} ) + ( {i}_{10} \times {k}_{10} ) + ( {i}_{11} \times {k}_{11} )$$

$${o}_{01} = ( {i}_{01} \times {k}_{00} ) + ( {i}_{02} \times {k}_{01} ) + ( {i}_{11} \times {k}_{10} ) + ( {i}_{12} \times {k}_{11} )$$

$${o}_{10} = ( {i}_{10} \times {k}_{00} ) + ( {i}_{11} \times {k}_{01} ) + ( {i}_{20} \times {k}_{10} ) + ( {i}_{21} \times {k}_{11} )$$

$${o}_{11} = ( {i}_{11} \times {k}_{00} ) + ( {i}_{12} \times {k}_{01} ) + ( {i}_{21} \times {k}_{10} ) + ( {i}_{22} \times {k}_{11} )$$

etc.

An appropriate kernel matrix can be derived as follows and the input matrix takes a smaller “window” of input data (i.e. the input data is 4×4) and is rearranged appropriately into a 4×8 input matrix:

$$[ \begin{matrix}{i}_{00} & {i}_{01} & {i}_{02} & {i}_{03} & {i}_{10} & {i}_{11} & {i}_{12} & {i}_{13} \\ {i}_{10} & {i}_{11} & {i}_{12} & {i}_{13} & {i}_{20} & {i}_{21} & {i}_{22} & {i}_{23} \\ {i}_{20} & {i}_{21} & {i}_{22} & {i}_{23} & {i}_{30} & {i}_{31} & {i}_{32} & {i}_{33} \\ {i}_{30} & {i}_{31} & {i}_{32} & {i}_{33} & {i}_{40} & {i}_{41} & {i}_{42} & {i}_{43}\end{matrix} ] [ \begin{matrix}{k}_{00} & 0 & 0 \\ {k}_{01} & {k}_{00} & 0 \\ 0 & {k}_{01} & {k}_{00} \\ 0 & 0 & {k}_{01} \\ {k}_{10} & 0 & 0 \\ {k}_{11} & {k}_{10} & 0 \\ 0 & {k}_{11} & {k}_{10} \\ 0 & 0 & {k}_{11}\end{matrix} ] = [ \begin{matrix}{o}_{00} & {o}_{01} & {o}_{02} \\ {o}_{10} & {o}_{11} & {o}_{12} \\ {o}_{21} & {o}_{21} & {o}_{22} \\ {o}_{30} & {o}_{31} & {o}_{32}\end{matrix} ]$$

Again, as for Example 2, a full output can be derived by repeating this process with the same kernel matrix and a second input matrix that starts at a corresponding position in the input data (for example at column 4 in this example).

Alternatively, the input can be rearranged into an input matrix, with more rows, to obtain more valid outputs for a single multiplication, as follows:

$$[ \begin{matrix}{i}_{00} & {i}_{01} & {i}_{02} & {i}_{03} & {i}_{10} & {i}_{11} & {i}_{12} & {i}_{13} \\ {i}_{03} & {i}_{04} & {i}_{05} & {i}_{06} & {i}_{13} & {i}_{14} & {i}_{15} & {i}_{16} \\ {i}_{10} & {i}_{11} & {i}_{12} & {i}_{13} & {i}_{20} & {i}_{21} & {i}_{22} & {i}_{23} \\ {i}_{13} & {i}_{14} & {i}_{15} & {i}_{16} & {i}_{23} & {i}_{24} & {i}_{25} & {i}_{26} \\ {i}_{20} & {i}_{21} & {i}_{22} & {i}_{23} & {i}_{30} & {i}_{31} & {i}_{32} & {i}_{33} \\ {i}_{23} & {i}_{24} & {i}_{25} & {i}_{26} & {i}_{33} & {i}_{34} & {i}_{35} & {i}_{36} \\ {i}_{30} & {i}_{31} & {i}_{32} & {i}_{33} & {i}_{40} & {i}_{41} & {i}_{42} & {i}_{43} \\ {i}_{33} & {i}_{34} & {i}_{35} & {i}_{36} & {i}_{43} & {i}_{44} & {i}_{45} & {i}_{46}\end{matrix} ] [ \begin{matrix}{k}_{00} & 0 & 0 \\ {k}_{01} & {k}_{00} & 0 \\ 0 & {k}_{01} & {k}_{00} \\ 0 & 0 & {k}_{01} \\ {k}_{10} & 0 & 0 \\ {k}_{11} & {k}_{10} & 0 \\ 0 & {k}_{11} & {k}_{10} \\ 0 & 0 & {k}_{11}\end{matrix} ] = [ \begin{matrix}{o}_{00} & {o}_{01} & {o}_{02} \\ {o}_{03} & {o}_{04} & {o}_{05} \\ {o}_{10} & {o}_{11} & {o}_{12} \\ {o}_{13} & {o}_{14} & {o}_{15} \\ {o}_{21} & {o}_{21} & {o}_{22} \\ {o}_{23} & {o}_{24} & {o}_{25} \\ {o}_{30} & {o}_{31} & {o}_{32} \\ {o}_{33} & {o}_{34} & {o}_{35}\end{matrix} ]$$

In this alternative of Example 3, the output matrix would need to be re-arranged or translated or mapped to the final output for this processing step.

In this example, 2D convolution can be done by manipulating the input data in the input matrix and by interleaving and combining rows of elements (equal to kernel size). The kernel is also modified in this way, say for example a 3×3 kernel can be modified to be 1×9 and then a suitable matrix, such as a transposed sparse circulant or transposed sparse circulant matrix (square or non-square) can be created. This way the kernel can be less sparse.

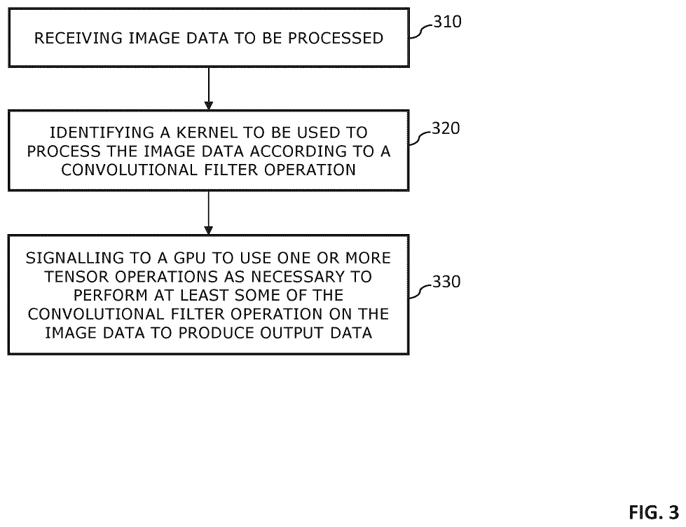

FIG. 3 is a flowchart outlining a method according to an aspect of the invention. At step 310, the method comprises receiving image state to be processed. At step 320, the method comprises identifying a kernel to be used to process the image data according to a convolutional filter operation. At step 330, the method comprises signalling to a GPU to use one or more tensor operations as necessary to perform at least some of the convolutional filter operation on the image data to produce output data.

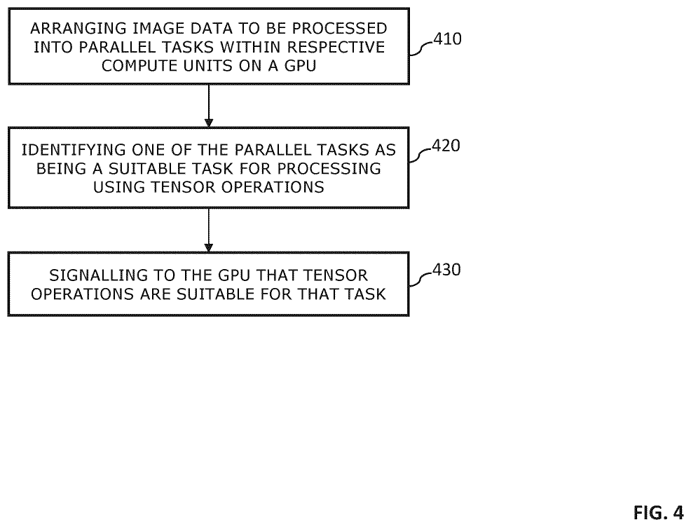

FIG. 4 is a flowchart outlining a method according to another aspect of the invention. At step 410, the method comprises arranging image data to be processed into parallel tasks within respective compute units on a GPU. At step 420, the method comprises identifying one of the parallel tasks as being a suitable task for processing using tensor operations. At step 430, the method comprises signalling to the GPU that tensor operations are suitable for that task.

### LCEVC Implementation

mpeg-5 part 2 LCEVC (Low Complexity Enhancement Video Coding) ISO/IEC 23094-2:2021(en) is a published standard for video decoding. It specifies an enhancement layer which, when combined with a base video encoded with a separate codec, produces an enhanced video stream. It is suitable for a software processing implementation with sustainable power consumption. The enhancement video stream provides new features such as: extending the compression capability of the base codec; lowering encoding and decoding complexity; providing a platform for additional future enhancements.

LCEVC works by encoding a lower resolution version of an input image using any existing codec (the base codec) and the difference between the reconstructed lower resolution image and the source using a different compression method (the enhancement).

The remaining details that make up the difference with the source are efficiently and rapidly compressed with LCEVC, which uses specific tools designed to compress residual data. The LCEVC enhancement compresses residual information on at least two layers, one at the resolution of the base to correct artefacts caused by the base encoding process and one at the source resolution that adds details to reconstruct the output frames. Between the two reconstructions the picture is upsampled.

Generally, LCEVC encoder and decoder perform one or more of downsampling, upsampling and other filtering operations to encode and decode pictures.

The enhancement layer can be decoded independently of the base layer.

Post upsampling and/or downsampling operations and in some instances prior to upsampling and/or downsampling operations, one or more filtering operations may take place. The codec may use tensor core operations to do the one or more filtering operations as discussed herein, for example, when the tensor cores are available and the CUDA cores are in use. The codec may also use tensor core operations to perform transform operations such as DD, inverse DD, DDS and inverse DDS transforms.

A tensor operation is a programmable matrix-multiply-and-accumulate task. In this disclosure, the accumulate part of the task is sometimes not used and the matrix multiply part of the task is used.

The above embodiments are to be understood as illustrative examples. Further embodiments are envisaged. It is to be understood that any feature described in relation to any one embodiment may be used alone or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A method of processing image data on a GPU, the method comprising:
receiving image data to be processed;
identifying a kernel to be used to process the image data according to a convolutional filter operation; and
signalling to the GPU to use one or more tensor operations as necessary to perform at least some of the convolutional filter operation on the image data to produce output data.

2. The method of claim 1, wherein the identifying comprises generating a kernel matrix from the kernel so that the convolutional filter operation can be performed by matrix multiplication using tensor operations on the GPU.

3. The method of claim 2, wherein when the kernel is a separable 2D kernel the kernel is transposed into a 1D kernel prior to creating the kernel matrix and the image data is adapted accordingly to define an input matrix.

4. The method of claim 2, wherein the image data is reordered to populate an or the input matrix so that when multiplied by the kernel matrix the output data obtained is equivalent to the convolutional filter operation.

5. The method of claim 2, wherein the kernel matrix is obtained by transposing the kernel and is one of: a transposed circulant matrix derived from the kernel; a transposed non-square circulant matrix derived from the kernel; a transposed Toeplitz matrix; a transposed non-square Toeplitz matrix.

6. The method of claim 5, wherein the method further comprises populating any columns of the kernel matrix that cannot accommodate the kernel according to the transposing with zero values once the transposing of the kernel is done and arranging the image data into successive input matrices accordingly to obtain the desired output data to recreate the output data that would have been produced by the convolutional filter operation.

7. The method of 1, wherein the image data is organised into one or more input matrices to according to the matrix size requirements of the tensor operations.

8. The method of claim 7, wherein the input matrix width dimension and the kernel matrix height dimension are chosen to match each other and so that the kernel matrix can accommodate the kernel.

9. The method of claim 8, wherein the input matrix width dimension and the kernel matrix height dimension are chosen so that the kernel matrix has a relatively lower or lowest available sparsity for the given kernel.

10. The method of claim 1, wherein operative matrices are used, wherein M is the height of the input matrix, N is the width of the kernel matrix and K is the width of the input matrix and the height of the kernel matrix.

11. The method of claim 10, wherein one of the following matrix sizes M, N, K for operative matrices are used: 16, 16, 16; 16, 8, 16; 16, 8, 8; 16, 16, 32; 16, 8, 32; and 8, 8, 32 depending on the image data and the kernel.

12. The method of claim 1, wherein the method comprises reordering the output data as needed to recreate the output data that would have been produced by the convolutional filter operation.

13. The method of claim 1, wherein the convolutional filter operation is one of the following: downsampling; upsampling; or another filtering operation or combination of downsampling or upsampling and another filtering operation.

14. The method of claim 1, wherein the method comprises initialising a shared kernel buffer and temporary buffer memories.

15. A method of coding image data on a GPU, the method comprising:
arranging image data to be processed into parallel tasks within respective compute units on the GPU;
identifying one of the parallel tasks as being a suitable task for processing using tensor operations; and
signalling to the GPU that tensor operations are suitable for that task.

16. The method of claim 15, wherein the suitable task is one of the following: downsampling; upsampling; or filtering.

17. The method of claim 15, wherein the method involves independently encodable and decodable parts.

18. The method of claim 17, wherein the independently encodable and decodable parts are one or more of: encode or decode a base layer; encode or decode an enhancement layer; encode or decode part of an enhancement layer while in parallel simultaneously decoding another part of the same enhancement layer; upsampling a base layer while decoding an enhancement layer, or part thereof.

19. The method of claim 15, wherein the signalling to the GPU comprises signalling using a cooperative matrix extension.

20. The method of claim 15, wherein the signalling to the GPU involves specifying the instruction in a particular way different to a normal instruction and wherein the signalling comprises using metadata.

21. (canceled)

22. (canceled)

23. (canceled)

24. (canceled)
